(19) United States
(12) Patent Application Publication
(10) Pub. No.: US 2005/0079112 A1
(43) Pub. Date: Apr. 14, 2005

(54) Surface discharge non-thermal plasma reactor and method

(76) Inventors: Bob Xiaobin Li, Grand Blanc, MI (US); Mark David Hemingway, Columbiaville, MI (US)

Correspondence Address: DELPHI TECHNOLOGIES, INC., M/C 480-410-202, PO BOX 5052, TROY, MI, 48007, US

(21) Appl. No.: 10/682,264

(22) Filed: Oct. 9, 2003

(51) Int. Cl. B01J 19/08; C01B 21/00

(52) U.S. Cl. 422/186.03; 29/592.1; 423/213.2

(57) ABSTRACT

A surface discharge non-thermal plasma reactor includes a plurality of surface discharge reactor elements arranged in a stack and having a surface discharge gap formed between adjacent pairs of elements. Individual surface discharge elements include a dielectric substrate having disposed thereon first and second polarity surface discharge electrodes. Surface discharge electrode patterns and substrate configurations are provided to selectively control the volume of nitric oxide (NO) produced from a nitrogen-containing gas stream being treated in the reactor. In a preferred embodiment, surface discharge electrode and dielectric substrate configurations are arranged to maximize the production of NO. The surface discharge electrodes and substrates are combined and connected to a power supply to form various embodiments such as reactor stacks having a plurality of positive surface discharge gaps, reactor stacks having a plurality of negative surface discharge gaps, and reactor stacks having a plurality of alternating positive and negative surface discharge gaps.

### TECHNICAL FIELD

The present invention relates generally to the treatment of nitrogen oxide (NOx) emissions from combustion exhaust gases, particularly combustion exhaust gases from diesel and other engines operating with lean air fuel mixtures that produce relatively high emission of NOx. More particularly, the invention relates to an on-board surface discharge non-thermal plasma reactor for generating NO to form ammonia which is used as a co-reductant in a selective catalytic reduction system and a method for fabricating the surface discharge non-thermal plasma reactor.

### BACKGROUND OF THE INVENTION

Certain compounds in the exhaust stream of a combustion process, such as the exhaust stream from an internal combustion engine, are undesirable in that they must be controlled in order to meet government emissions regulations. Among the regulated compounds are hydrocarbons, soot particulates, and nitrogen oxide compounds (NOx). There are a wide variety of combustion processes producing these emissions, for instance, coal- or oil-fired furnaces, reciprocating internal combustion engines (including gasoline spark ignition and diesel engines), gas turbine engines, and so on. In each of these combustion processes, control measures to prevent or diminish atmospheric emissions of these emissions are needed.

Industry has devoted considerable effort to reducing regulated emissions from the exhaust streams of combustion processes. In particular, it is now usual in the automotive industry to place a catalytic converter in the exhaust system of gasoline spark ignition engines to remove undesirable emissions from the exhaust by chemical treatment. Typically, a “three-way” catalyst system of platinum, palladium, and rhodium metals dispersed on an oxide support is used to oxidize carbon monoxide and hydrocarbons to water and carbon dioxide and to reduce nitrogen oxides to nitrogen. When a spark ignition engine is operating under stoichiometric conditions or nearly stoichiometric conditions with respect to the fuel-air ratio (just enough oxygen to completely combust the fuel, or perhaps up to 0.3% excess oxygen), a “three-way” catalyst has proven satisfactory for reducing emissions. Unburned fuel (hydrocarbons) and oxygen are consumed in the catalytic converter, and the relatively small amount of excess oxygen does not interfere with the intended operation of the conventional catalyst system.

However, it is desirable to operate the engine at times under lean burn conditions, with excess air, in order to improve fuel economy. Under lean burn conditions, conventional catalytic devices are not very effective for treating the NOx in the resulting oxygen-rich exhaust stream. The exhaust stream from a diesel engine also has substantial oxygen content, from perhaps about 2 to about 18% oxygen, and, in addition, contains a significant amount of particulate emissions, or soot, which is thought to be primarily carbonaceous particles and volatile organic compounds (VOC).

There are numerous ways known in the art to remove NOx from a waste gas. Several techniques have been proposed to modify the exhaust chemistry enabling the use of existing catalyst technology. In spite of efforts over the last decade to develop an effective catalyst for reducing NOx to nitrogen under oxidizing conditions in a spark ignition gasoline engine and in a diesel engine, the need for improved conversion effectiveness has remained unsatisfied. Moreover, there is a continuing need for improved effectiveness in treating emissions from any combustion process, particularly for simultaneously treating the nitrogen oxides and soot particulate emissions from diesel engines.

Catalytic reduction methods, such as selective catalytic reduction (SCR) systems, for removing NOx generally comprise passing the exhaust gas over a catalyst bed in the presence of a reducing gas to convert the NOx into nitrogen. For diesel exhaust after treatment, ammonia (NH₃) can be used as a reducing catalyst in an SCR system to achieve reduction of NOx in the diesel exhaust stream. On-board ammonia delivery systems have been designed to deliver ammonia to the diesel exhaust pipe line upstream of the SCR catalyst.

A technique that has been successfully applied in large stationary applications comprises injecting urea into the exhaust stream ahead of the catalytic converter where it quickly decomposes to ammonia. The ammonia reacts with NO and NO₂ in the exhaust stream on the catalytic converter surface to form N₂ and H₂O. Some of the challenges presented when using this technology in a mobile emitter include: (1) storing the aqueous urea solution onboard and preventing it from freezing under cold ambient temperature conditions; (2) correctly metering the urea solution into the exhaust (too much urea can result in ammonia emissions, too little urea can cause high NOx emissions); and (3) replenishing the urea—this requires establishing a supply network to distribute urea and customer acceptance of the expense and inconvenience in maintaining an adequate urea supply onboard the vehicle.

The assignee of the present invention has successfully designed and built a non-thermal plasma reactor for treating exhaust emissions using volume discharge technology. In such systems, a glow plasma discharge is generated in the gas flow channel between the electrodes to convert nitric oxide to nitrogen dioxide. Commonly assigned U.S. Pat. No. 6,464,945 to Hemingway (Oct. 15, 2002), incorporated by reference herein in its entirety, teaches an NOx reducing exhaust treatment system including a non-thermal plasma reactor assembly which initiates NOx reduction reactions that are completed by a catalytic converter downstream of the reactor in the system. The reactor assembly includes a monolithic reactor element formed of insulating plates and spacers made of high dielectric material. Plates and spacers form a plurality of thin gas passages each lying between a pair of electrodes, one to be charged with an AC voltage and the other grounded to impress the alternating voltage across each passage. The voltage creates a non-thermal plasma in the passages that increases the activity of electrons in the exhaust gases and initiates breakdown of the NOx primarily to NO₂ and other reaction products in the gases. The reactions are then completed in a downstream catalytic converter, resulting in reduced emissions of NOx as well as other controlled emissions in the treated exhaust gases. The energy density in the volume discharge non-thermal plasma reactor is below 400 Townsend. The average kinetic energy of electrons in the gas phase volume discharge being less than about 10 eV, there is not a sufficient energy density to dissociate the N₂ bond. At this energy level, there is dissociation of the O₂ bond.

### SUMMARY OF THE INVENTION

Surface discharge non-thermal plasma reactors employ one or more electrodes to produce surface plasma along the surfaces of the electrodes. In contrast to volume discharge non-thermal plasma devices, the surface discharge non-thermal plasma reactor can achieve an energy density of over 400 Townsend in the discharge region. The high field intensity achieved with the surface discharge reactor is sufficient to dissociate the nitrogen bond and lead to the production of nitric oxide. See, for example, Pietsch and Humpert, Discharge Mechanism and Ozone Generation by Surface Discharges Depending on Polarity, International Symposium on High Pressure, Low Temperature Plasma Chemistry, Proceedings, 21-25 Jul. 2002, and Kozlov, et al., Surface Discharge Characteristics for Different Types of Applied Voltage and Different Dielectric Materials, International Symposium on High Pressure, Low Temperature Plasma Chemistry, Proceedings, 21-25 Jul. 2002, the disclosures of which are hereby incorporated by reference herein in their entireties. In contrast to a thermal plasma device such as a plasmatron, the non-thermal surface discharge plasma reactor does not produce heat. The energy generated therein is more efficiently used for breaking the nitrogen bond in N₂.

The present invention provides a surface discharge non-thermal plasma reactor comprising:
a plurality of reactor elements arranged in a stack;
a surface discharge gap formed via spacers disposed between adjacent pairs of reactor elements;
wherein individual reactor elements comprise:
a dielectric substrate;
a first polarity surface discharge electrode disposed on the dielectric substrate;
a second opposite polarity surface discharge electrode disposed on the dielectric substrate;
wherein the first and second polarity surface discharge electrodes are disposed on the dielectric substrate in a pattern providing a surface discharge sufficient to selectively control production of nitric oxide from a nitrogen-containing gas stream being treated in said reactor.

The invention exploits the field intensity capabilities of the surface discharge non-thermal plasma reactor and contemplates arranging surface discharge electrode and substrate configurations to selectively control the volume of nitric oxide (NO) produced. Several embodiments are illustrated herein to maximize the amount of NO produced, including surface discharge electrode and dielectric substrate configurations that form a plurality of all positive surface discharge gaps, a plurality of all negative surface discharge gaps, or a plurality of alternating positive-negative surface discharge gaps.

The present invention further comprises employing the present surface discharge non-thermal plasma reactor in a combustion exhaust treatment system to generate NO from an air stream. The NO is combined with hydrogen to generate ammonia via a catalyst to be used as a co-reductant in a selective catalytic reduction (SCR) catalyst. The combustion exhaust treatment system employing the present surface discharge non-thermal plasma reactor includes:
an air supply and a power supply connected to the surface discharge non-thermal plasma reactor;
a hydrogen source, such as an on-board hydrogen reformer, for supplying hydrogen to an exhaust stream from the surface discharge reactor to generate an ammonia containing exhaust stream via a first catalyst; and
a second catalyst connected to a combustion device for receiving a combustion exhaust stream and further connected to the ammonia-containing exhaust stream;
wherein during operation, an air stream is treated in the surface discharge non-thermal plasma reactor to generate a surface discharge NO-containing exhaust;
the surface discharge NO-containing exhaust is combined with hydrogen from the hydrogen source and fed to said first catalyst to generate ammonia;
the ammonia is fed into said second catalyst to be used as a co-reductant for treating the combustion exhaust stream;
the combustion exhaust stream being treated in said second catalyst to provide a catalyst treated exhaust stream comprising N₂, H₂O, CO₂, and O₂.

The present invention also provides a method for fabricating a surface discharge non-thermal plasma reactor comprising:
arranging a plurality of reactor elements to form a reactor stack;
disposing the reactor elements in the stack and placing spacers therebetween to provide a surface discharge gap between adjacent pairs of reactor elements;
forming individual reactor elements by:
providing a dielectric substrate;
disposing a first polarity surface discharge electrode on the dielectric substrate;
disposing a second opposite polarity surface discharge electrode on the dielectric substrate;
wherein disposing the first and second polarity electrodes comprises disposing the electrodes in a pattern providing a surface discharge sufficient to selectively control production of nitric oxide from a nitrogen-containing gas stream being treated in said reactor.

The present invention further provides a method for treating a combustion exhaust stream comprising:
treating an air stream in a surface discharge non-thermal plasma reactor to generate a NO-containing surface discharge exhaust;
supplying hydrogen to the NO-containing surface discharge exhaust and treating in a first catalyst to generate an ammonia containing exhaust stream;
generating a combustion exhaust stream and passing the combustion exhaust stream through a second catalyst;
passing the ammonia-containing exhaust stream through the second catalyst to be used as a co-reductant for treating the combustion exhaust stream;
wherein the combustion exhaust stream is treated in the second catalyst to provide a catalyst treated exhaust stream comprising N₂, H₂O, CO₂, and O₂.

These and other features and advantages of the invention will be more fully understood from the following description of certain specific embodiments of the invention taken together with the accompanying drawings.

### BRIEF DESCRIPTION OF THE DRAWINGS

Referring now to the drawings, which are meant to be exemplary, not limiting, and wherein like elements are numbered alike in the several Figures:

FIGS. 1A, 1B, and 1C represent a substrate and electrode pattern configuration in accordance with one possible embodiment of the present invention.

FIGS. 2A, 2B, and 2C represent a substrate and electrode pattern configuration in accordance with another possible embodiment of the present invention.

FIGS. 3A, 3B, 3C, and 3D represent a surface discharge element having substrate and electrode patterns of FIG. 1 or FIG. 2 with a thin layer of dielectric material coated over the electrodes.

FIGS. 4A, 4B, and 4C represent a surface discharge element in accordance with another embodiment of the present invention.

FIGS. 5A and 5B represent a co-planar surface discharge element having a substrate and electrode pattern configuration in accordance with yet another embodiment of the present invention.

FIG. 6 is a representation of a reactor stack including a plurality of surface discharge elements forming an alternating arrangement of positive and negative surface discharge gaps in accordance with the present invention.

FIG. 7 is a representation of a reactor stack including a plurality of surface discharge elements forming a plurality of positive surface discharge gaps in accordance with yet another embodiment of the present invention.

FIG. 8 is a representation of a reactor stack including a plurality of surface discharge elements forming a plurality of negative surface discharge gaps in accordance with yet another embodiment of the present invention.

FIG. 9 is a representation of a reactor stack including a plurality of co-planar elements in accordance with yet another embodiment of the present invention.

FIG. 10 is a block schematic diagram showing the present invention utilized in the application of an engine exhaust treatment system.

### DESCRIPTION OF THE PREFERRED EMBODIMENT

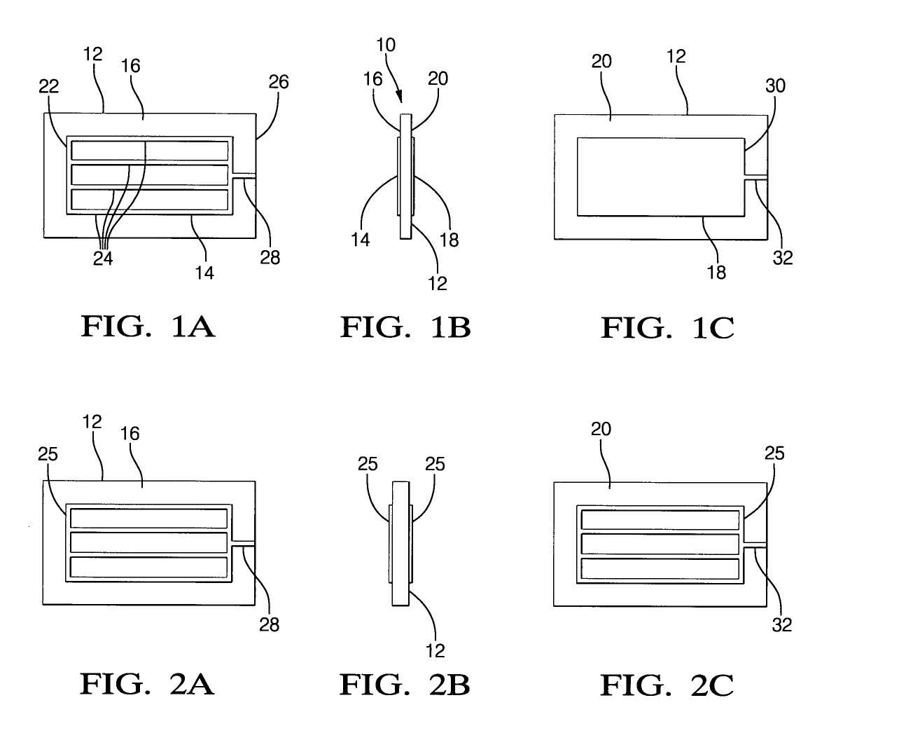

Surface discharge non-thermal plasma reactors in accordance with the present invention use surface discharge to generate a high intensity electric field for treating a nitrogen-containing gas stream (e.g., air). During treatment, the nitrogen bond is dislodged to form nitric oxide (NO) which can be used to produce ammonia for an SCR catalyst treatment device. Turning now to FIGS. 1A, 1B and 1C, a representation of a substrate and electrode pattern configuration 10 in accordance with one possible embodiment of the present invention includes a dielectric substrate 12 having a first electrode 14 printed on a first side 16 of the dielectric substrate 12 and a second electrode 18 printed on a second opposite side 20 of the dielectric substrate 12. The electrode 14 is disposed in a mesh pattern 22 comprising a plurality of parallel conductive strips 24 connected at one side 26 to a terminal lead 28 for connecting to a first polarity electrical busline (not shown). The electrode 18 is shown having a solid electrode pattern 30 including a terminal lead 32 for connecting to a second opposite polarity electrical busline (not shown).

In another embodiment, as shown in FIGS. 2A, 2B, and 2C, the same mesh-like pattern 25 is used for the first electrode and the second electrode to effect a rapid charge and discharge of the substrate 12. The particular electrode pattern is merely illustrative and in no way limiting. Numerous alternate patterns for the positive and negative electrode and terminal leads are contemplated and constitute part of the present invention. Terminal leads 28, 32 are disposed on the substrate 12 is a manner designed to prevent arcing. For example, terminal leads 28, 32 can be disposed on opposite sides of the dielectric substrate 12. Alternately, if disposed on the same side of the dielectric substrate 12, terminal leads 28, 32 can be separated by a distance sufficient to prevent arcing.

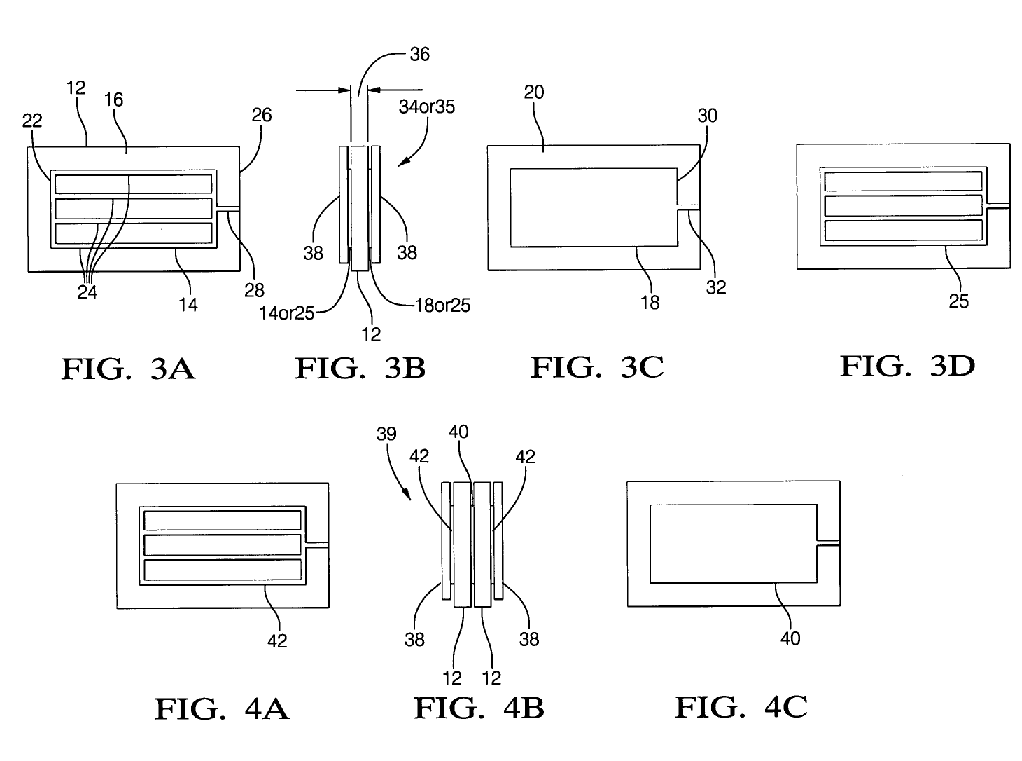

FIGS. 3A, 3B, 3C, and 3D show two possible embodiments of a basic surface discharge element 34 or 35 in accordance with the present invention. In the first embodiment, the element 34 is shown in FIG. 3B and includes a dielectric substrate in the form of a plate 12 having an electrode 14 as shown in FIG. 3A printed on a first side 16 of the plate 12 and an electrode 18 as shown in FIG. 3C printed on a second opposite side 20 of the plate 12. Alternately, in the second embodiment, the element 35 includes a dielectric plate 12 having an electrode 25 as shown in FIG. 3D printed on both the first side 16 and second side 20 of the plate 12 (i.e., the same electrode pattern is used for both sides). Any suitable material may be employed to form the dielectric substrate including, but not limited to, alumina, dense cordierite, mullite, titania, plastic, and other high dielectric constant materials, or a combination thereof. Preferably, the dielectric plate 12 has a thickness 36 of about 0.3 to about 0.5 millimeters. A protective coating 38 is provided over the electrodes 14, 18, 25 in the form of a thin layer 38 of dielectric material laminated over the electrodes 18, 24, 25.

An alternate embodiment surface discharge element 39 is shown in FIGS. 4A, 4B, and 4C including first and second dielectric plates 12, 12 having a first polarity center electrode 40 having a solid electrode pattern sandwiched between the first and second dielectric plates 12, 12. A second opposite polarity outer electrode 42 having a grid pattern is disposed on the two opposite outer sides of dielectric plates 12, 12. A protective coating 38 is provided over the outer electrodes 42 such as in the form of a thin layer 38 of dielectric material laminated over the electrodes 42. The various elements can be prepared using a lamination process resulting in electrodes being completely buried inside the dielectric material. Examples of suitable processes for preparing the elements include, but are not limited to, high temperature co-fired ceramic (HTCC) or low temperature co-fired ceramic (LTCC) processes.

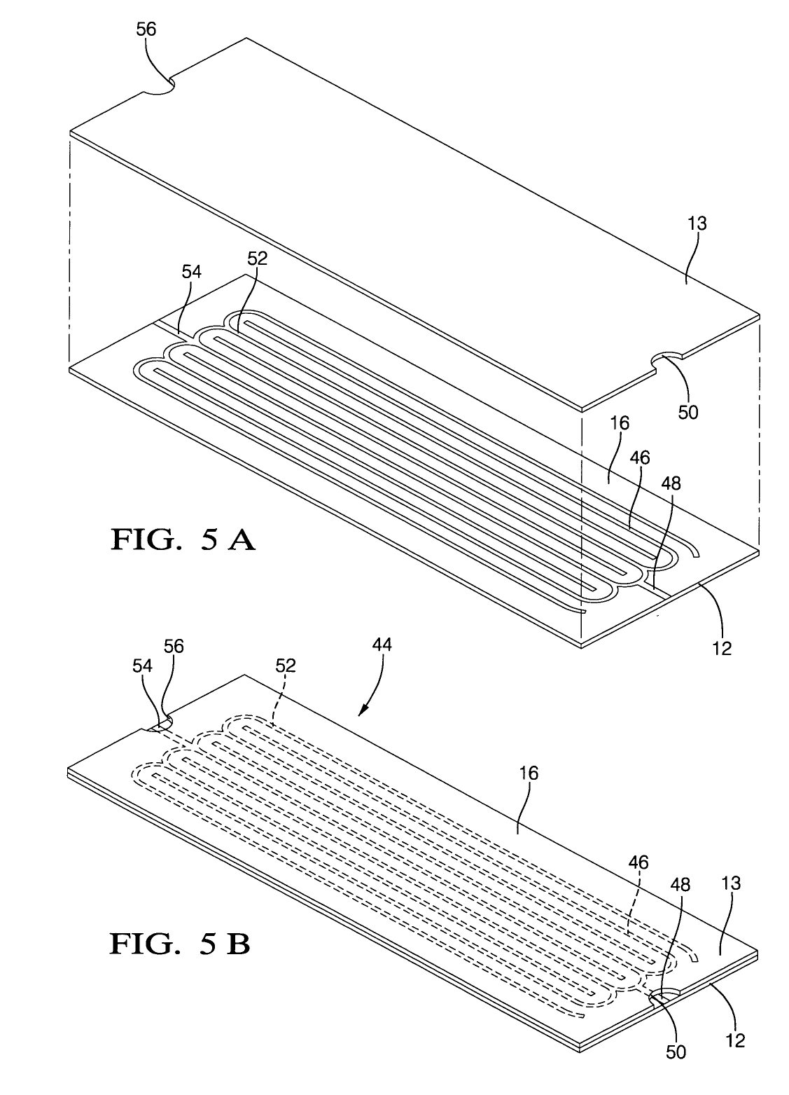

FIGS. 5A and 5B represent yet another embodiment for the basic surface discharge element comprising a co-planar surface discharge element 44. Co-planar surface discharge element 44 includes a first dielectric substrate 12 in the form of a plate 12 having a first polarity (positive) electrode 46 printed on a first side 16 of the plate 12 and a second embedded opposite polarity electrode 52 printed on and embedded into the same first side 16 of the plate 12. A second dielectric substrate 13 in the form of a plate 13 includes two cutout regions 50 and 56 disposed at opposite sides of the plate 13. The second plate 13 is disposed over the first plate 12 and plates 12 and 13 are laminated together to provide a single element 44. Again, for example, a high temperature co-fired ceramic process or a low temperature co-fired ceramic process can be used to fabricate the element design.

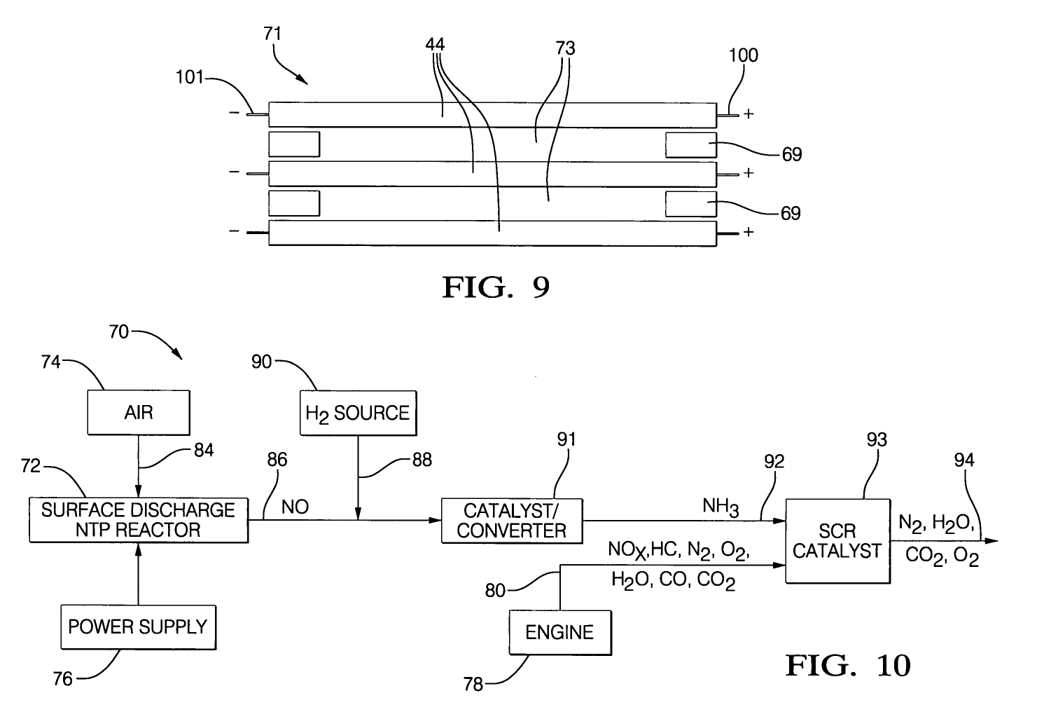

One possible pattern for positive electrode 46 and ground electrode 52 is shown in FIGS. 5A and 5B. The electrode 46 is connected at a first end to a positive terminal lead 48 and further connected to a positive busline (not shown). The electrode 52 is connected to the negative terminal lead 54 and further connected to a negative busline (not shown). The cutout features 50, 56 are designed for the attachment of terminal clips 100, 101 as shown in FIG. 9 (FIG. 9 showing a substrate stack including surface discharge co-planar elements 44 with gas flow channels.)

Various embodiments of the surface discharge non-thermal plasma reactor are constructed by varying the configuration of the elements and the electrode connection to the power supply. The various embodiments of the surface discharge non-thermal plasma reactor comprise a plurality of reactor elements arranged in a stack to provide a surface discharge gap formed between adjacent pairs of the reactor elements. As described herein, the individual reactor elements making up the stack comprise a dielectric substrate having a first polarity surface discharge electrode disposed on the dielectric substrate; a second polarity surface discharge electrode disposed on the dielectric substrate; with the first and second polarity surface discharge electrodes being disposed on the dielectric substrate in a pattern designed to effect a surface discharge that selectively controls production of nitric oxide from a nitrogen-containing gas stream.

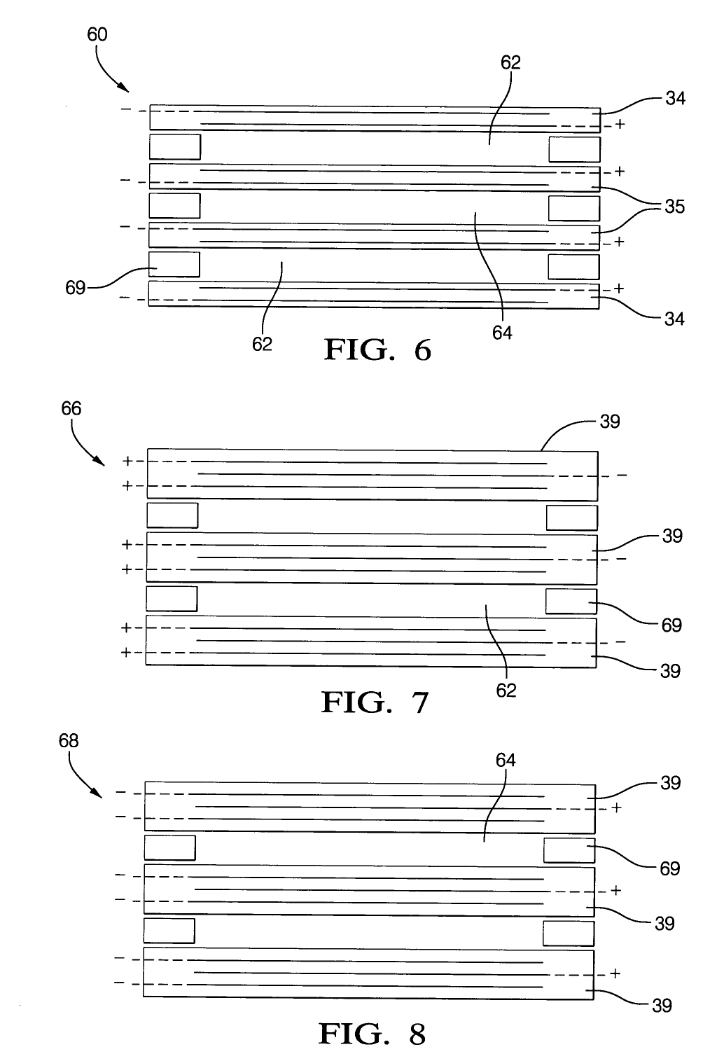

FIG. 6 represents a substrate stack 60 in accordance with one embodiment of the present invention using a plurality of surface discharge elements and spacers 69 to prepare the stack 60. Stack 60 includes elements, such as element 34, disposed on the top and bottom of the stack with solid ink pattern facing away from discharge gap, elements, such as element 35, comprising the middle of the stack, and spacers 69 arranged to create an alternating positive-negative surface discharge gap configuration forming negative discharge gap 64 and positive discharge gap 62 by connecting the power supply to the substrate as shown. (“Plus” sign indicating connection to high voltage power source; “negative” sign indicating ground.)

FIG. 7 is a representation of another embodiment of the present invention comprising a reactor stack 66 including a plurality of surface discharge elements, such as surface discharge elements 39, and spacers 69, arranged to provide a plurality of positive surface discharge gaps 62.

FIG. 8 is a representation of yet another embodiment of the present invention comprising a reactor stack 68 including a plurality of surface discharge elements, such as surface discharge elements 39, arranged to provide a plurality of negative surface discharge gaps 64 by reversing the power polarity hookup to the reactor terminals.

FIG. 9 is a representation of yet another embodiment of the present invention comprising a reactor stack 71 including a plurality of co-planar surface discharge elements, such as co-planar surface discharge elements 44, and spacers 69 arranged to provide a plurality of mixed polarity surface discharge gaps 73 (i.e., positive and negative polarity in the same plane). Terminal clips 100, 101 brazed to the element 44 over the terminal leads 48 and 54, are bent, lapped one over the other, and welded for the construction of the busline.

FIG. 10 shows in block schematic form a surface discharge non-thermal plasma reactor 72 in accordance with the present invention in an exhaust treatment system 70. The exhaust treatment system 70 may be advantageously employed to treat an exhaust stream from combustion devices such as, but not limited to, coal fired furnaces, oil fired furnaces, reciprocating internal combustion engines, gasoline spark ignition engines, diesel engines, or gas turbine engines. While the present invention may be advantageously employed to treat combustion exhaust streams generally, it is particularly suited for treating a diesel engine exhaust stream typically comprising particulates, HC, N₂, NOx (NO, NO₂), O₂, H₂O, CO, and CO₂.

In the embodiment of FIG. 10, surface discharge non-thermal plasma reactor 72 is connected to an air supply such as an air pump 74 and a power supply 76. The system 70 includes a combustion device such as diesel engine 78 that generates a combustion exhaust stream 80 which includes NOx, N₂, particulate matter, HC, O₂, H₂O, CO, and CO₂. The diesel engine exhaust stream 80 is connected to a selective catalytic reduction (SCR) catalyst 93 for receiving and treating the combustion exhaust stream 80. During operation, an air stream 84 is treated in the surface discharge non-thermal plasma reactor 72 to generate NO from the air stream 84. The surface discharge NO-containing exhaust 86 is combined with hydrogen 88 from a hydrogen source 90, such as an on-board hydrogen reformer, to generate ammonia 92 via a catalyst 91. The ammonia 92 is fed into the SCR catalyst 93 to be used as a co-reductant for treating the diesel engine exhaust stream 80. The diesel engine exhaust stream 80 is treated in the SCR catalyst 93 to provide a catalyst treated exhaust stream 94 comprising N₂, H₂O, CO₂, O₂, etc. Suitable connections, inlets and outlets, etc. will be readily known to those of skill in the art and are not discussed in order to focus on the various aspects of the present invention.

While the invention has been described by reference to certain preferred embodiments, it should be understood that numerous changes could be made within the spirit and scope of the inventive concepts described. Accordingly, it is intended that the invention not be limited to the disclosed embodiments, but that it have the full scope permitted by the language of the following claims.

1. A surface discharge non-thermal plasma reactor comprising:
a plurality of surface discharge non-thermal plasma reactor elements arranged in a stack;
a surface discharge gap formed via spacers disposed between adjacent pairs of said reactor elements;
wherein individual said reactor elements comprise:
a dielectric substrate;
a first polarity surface discharge electrode disposed on said dielectric substrate;
a second opposite polarity surface discharge electrode disposed on said dielectric substrate;
wherein said first and second polarity surface discharge electrodes are disposed on said dielectric substrate in a pattern providing a surface discharge sufficient to selectively control production of nitric oxide from a nitrogen-containing gas stream being treated in said reactor.

2. The surface discharge non-thermal plasma reactor of claim 1, wherein said electrode pattern is a pattern sufficient to provide a surface discharge which maximizes production of nitric oxide from a nitrogen-containing gas stream.

3. The surface discharge non-thermal plasma reactor of claim 1, wherein said dielectric substrate is a dielectric plate having a first side and a second opposite side; and
said first polarity surface discharge electrode is disposed on said first side of said plate; and
said second polarity electrode is disposed on said second side of said plate.

4. The surface discharge non-thermal plasma reactor of claim 1, wherein at least one of said first and second polarity electrodes includes an electrode pattern comprising a plurality of parallel conductive strips connected at one side to a terminal lead.

5. The surface discharge non-thermal plasma reactor of claim 1, wherein at least one of said first and second polarity electrodes includes an electrode pattern comprising a solid electrode portion connected to a terminal lead.

6. The surface discharge non-thermal plasma reactor of claim 1, further comprising:
a protective coating provided over said first and second polarity electrodes.

7. The surface discharge non-thermal plasma reactor of claim 1, wherein said dielectric substrate forming said reactor elements comprises:
first and second dielectric plates each having a first side and a second opposite side, said first and second dielectric plates being disposed to have said first sides of said plates facing one another;
said first polarity electrode comprising a center electrode sandwiched between said first sides of said first and second dielectric plates; and
said second opposite polarity electrode comprising outer electrodes being disposed on said second opposite sides of said first and second dielectric plates.

8. The surface discharge non-thermal plasma reactor of claim 1, wherein said reactor element comprises a co-planar surface discharge element wherein:
said dielectric substrate comprises first and second dielectric plates;
said first polarity electrode being disposed on a first side of said first dielectric plate and said second opposite polarity electrode being disposed on said first side of said first dielectric plate;
wherein said second dielectric plate includes a first cutout region disposed at a first end of said second dielectric plate suitable for attachment of a first electrical busline and a second cutout region disposed at a second end of said second dielectric plate suitable for attachment of a second electrical busline; and
wherein said first and second dielectric plates are laminated together to provide said co-planar surface discharge element.

9. The surface discharge non-thermal plasma reactor of claim 1, wherein said surface discharge gaps formed between adjacent pairs of said reactor elements comprise an alternating series of positive and negative surface discharge gaps.

10. The surface discharge non-thermal plasma reactor of claim 1, wherein said surface discharge gaps formed between adjacent pairs of said reactor elements comprise all positive surface discharge gaps.

11. The surface discharge non-thermal plasma reactor of claim 1, wherein said surface discharge gaps formed between adjacent pairs of said reactor elements comprise all negative surface discharge gaps.

12. A combustion exhaust treatment system comprising:
an air supply and a power supply connected to the surface discharge non-thermal plasma reactor of claim 1;
a hydrogen source for supplying hydrogen to an exhaust stream of said surface discharge reactor to generate an ammonia containing exhaust stream via a first catalyst; and
a second catalyst connected to a combustion device for receiving a combustion exhaust stream and further connected to said ammonia-containing exhaust stream;
wherein during operation, an air stream is treated in said surface discharge non-thermal plasma reactor to generate a surface discharge NO-containing exhaust;
said surface discharge NO-containing exhaust is combined with hydrogen from said hydrogen source and fed to said first catalyst to generate ammonia;
said ammonia is fed into said second catalyst to be used as a co-reductant for treating said combustion exhaust stream;
said combustion exhaust stream being treated in said second catalyst to provide a catalyst treated exhaust stream comprising N₂, H₂O, CO₂, and O₂.

13. The combustion exhaust treatment system of claim 12, wherein said electrode pattern is a pattern sufficient to provide a surface discharge sufficient to maximize production of nitric oxide from a nitrogen-containing gas stream.

14. The combustion exhaust treatment system of claim 12, wherein said dielectric substrate is a dielectric plate having a first side and a second opposite side; and
said first polarity surface discharge electrode is disposed on said first side of said plate; and
said second polarity electrode is disposed on said second side of said plate.

15. The combustion exhaust treatment system of claim 12, wherein at least one of said first and second polarity electrodes includes an electrode pattern comprising a plurality of parallel conductive strips connected at one side to a terminal lead.

16. The combustion exhaust treatment system of claim 12, wherein at least one of said first and second polarity electrodes includes an electrode pattern comprising a solid electrode portion connected to a terminal lead.

17. The combustion exhaust treatment system of claim 12, further comprising:
a protective coating provided over said first and second polarity electrodes.

18. The combustion exhaust treatment system of claim 12, wherein said dielectric substrate forming said reactor elements comprises:
first and second dielectric plates each having a first side and a second opposite side, said first and second dielectric plates being disposed to have said first sides of said plates facing one another;
said first polarity electrode comprising a center electrode sandwiched between said first sides of said first and second dielectric plates; and
said second opposite polarity electrode comprising outer electrodes being disposed on said second opposite sides of said first and second dielectric plates.

19. The combustion exhaust treatment system of claim 12, wherein said reactor element comprises a co-planar surface discharge element wherein:
said dielectric substrate comprises first and second dielectric plates;
said first polarity electrode being disposed on a first side of said first dielectric plate and said second opposite polarity electrode being disposed on said first side of said dielectric plate;
wherein said second dielectric plate includes a first cutout region disposed at a first end of said second dielectric plate suitable for attachment of a first electrical busline and a second cutout region disposed at a second end of said second dielectric plate suitable for attachment of a second electrical busline; and
wherein said first and second dielectric plates are laminated together to provide said co-planar surface discharge element.

20. The combustion exhaust treatment system of claim 12, wherein said surface discharge gaps formed between adjacent pairs of said reactor elements comprise an alternating series of positive and negative surface discharge gaps.

21. The combustion exhaust treatment system of claim 12, wherein said surface discharge gaps formed between adjacent pairs of said reactor elements comprise all positive surface discharge gaps.

22. The combustion exhaust treatment system of claim 12, wherein said surface discharge gaps formed between adjacent pairs of said reactor elements comprise all negative surface discharge gaps.

23. A method for fabricating a surface discharge non-thermal plasma reactor comprising:
arranging a plurality of reactor elements to form a reactor stack;
disposing said reactor elements in said stack and placing spacers therebetween to provide a surface discharge gap between adjacent pairs of said reactor elements;
forming individual reactor elements by:
providing a dielectric substrate;
disposing a first polarity surface discharge electrode on said dielectric substrate;
disposing a second opposite polarity surface discharge electrode on said dielectric substrate;
wherein said disposing said first and second polarity electrodes comprises disposing said electrodes in a pattern providing a surface discharge sufficient to selectively control production of nitric oxide from a nitrogen-containing gas stream being treated in said reactor.

24. The method for fabricating a surface discharge non-thermal plasma reactor of claim 23, wherein said disposing said first and second polarity electrodes comprises:
disposing said electrodes in a pattern sufficient to provide a surface discharge which maximizes production of nitric oxide from a nitrogen-containing gas stream.

25. The method for fabricating a surface discharge non-thermal plasma reactor of claim 23, wherein said dielectric substrate is a dielectric plate having a first side and a second opposite side;
said disposing said first and second polarity electrodes comprises:
disposing said first polarity surface discharge electrode on said first side of said plate; and
disposing said second polarity electrode on said second side of said plate.

26. The method for fabricating a surface discharge non-thermal plasma reactor of claim 23, wherein said disposing said first and second polarity electrodes comprises:
disposing at least one of said first and second polarity electrodes in an electrode pattern comprising a plurality of parallel conductive strips connected at one side to a terminal lead.

27. The method for fabricating a surface discharge non-thermal plasma reactor of claim 23, wherein said disposing said first and second polarity electrodes comprises:
disposing at least one of said first and second polarity electrodes in an electrode pattern comprising a solid electrode portion connected to a terminal lead.

28. The method for fabricating a surface discharge non-thermal plasma reactor of claim 23, further comprising:
disposing a protective coating over said first and second polarity electrodes.

29. The method for fabricating a surface discharge non-thermal plasma reactor of claim 23, wherein providing said dielectric substrate comprises:
providing first and second dielectric plates each having a first side and a second opposite side, said first and second dielectric plates being disposed to have said first sides of said plates facing one another;
sandwiching said first polarity center electrode between said first sides of said first and second dielectric plates; and
disposing said second opposite polarity electrodes on said second opposite sides of said first and second dielectric plates to provide second polarity outer electrodes.

30. The method for fabricating a surface discharge non-thermal plasma reactor of claim 23, wherein said forming said individual reactor element comprises;
forming a plurality of co-planar surface discharge elements, wherein:
said dielectric substrate comprises first and second dielectric plates;
said first polarity electrode being disposed on a first side of said first dielectric plate and said second opposite polarity electrode being disposed on said first side of said dielectric plate;
wherein said second dielectric plate includes a first cutout region disposed at a first end of said second dielectric plate suitable for attachment of a first electrical busline and a second cutout region disposed at a second end of said second dielectric plate suitable for attachment of a second electrical busline; and
wherein said first and second dielectric plates are laminated together to provide said co-planar surface discharge element.

31. The method for fabricating a surface discharge non-thermal plasma reactor of claim 23, wherein said surface discharge gaps formed between adjacent pairs of said reactor elements comprise an alternating series of positive and negative surface discharge gaps.

32. The method for fabricating a surface discharge non-thermal plasma reactor of claim 23, wherein said surface discharge gaps formed between adjacent pairs of said reactor elements comprise all positive surface discharge gaps.

33. The method for fabricating a surface discharge non-thermal plasma reactor of claim 23, wherein said surface discharge gaps formed between adjacent pairs of said reactor elements comprise all negative surface discharge gaps.

34. A method for treating a combustion exhaust stream comprising:
treating an air stream in the surface discharge reactor of claim 1 to generate a NO-containing surface discharge exhaust;
supplying hydrogen to said NO-containing surface discharge exhaust and passing the hydrogen and NO-containing surface discharge exhaust stream through a first catalyst to generate an ammonia containing exhaust stream;
generating a combustion exhaust stream and passing said combustion exhaust stream through a second catalyst;
passing said ammonia-containing exhaust stream through said second catalyst to be used as a co-reductant for treating said combustion exhaust stream;
wherein said combustion exhaust stream is treated in said second catalyst to provide a catalyst treated exhaust stream comprising N₂, H₂O, CO₂, and O₂.

35. The method for treating a combustion exhaust stream of claim 34, wherein said electrode pattern is a pattern sufficient to provide a surface discharge sufficient to maximize production of nitric oxide from a nitrogen-containing gas stream.

36. The method for treating a combustion exhaust stream of claim 34, wherein said dielectric substrate is a dielectric plate having a first side and a second opposite side; and
said first polarity surface discharge electrode is disposed on said first side of said plate; and
said second polarity electrode is disposed on said second side of said plate.

37. The method for treating a combustion exhaust stream of claim 34, wherein at least one of said first and second polarity electrodes includes an electrode pattern comprising a plurality of parallel conductive strips connected at one side to a terminal lead.

38. The method for treating a combustion exhaust stream of claim 34, wherein at least one of said first and second polarity electrodes includes an electrode pattern comprising a solid electrode portion connected to a terminal lead.

39. The method for treating a combustion exhaust stream of claim 34, further comprising:
disposing a protective coating over said first and second polarity electrodes.

40. The method for treating a combustion exhaust stream of claim 34, wherein said dielectric substrate forming said reactor elements comprises:
first and second dielectric plates each having a first side and a second opposite side, said first and second dielectric plates being disposed to have said first sides of said plates facing one another;
said first polarity center electrode being sandwiched between said first sides of said first and second dielectric plates; and
said second opposite polarity electrode comprising outer electrodes being disposed on said second opposite sides of said first and second dielectric plates.

41. The method for treating a combustion exhaust stream of claim 34, wherein said reactor element comprises a co-planar surface discharge element wherein:
said dielectric substrate comprises first and second dielectric plates;
said first polarity electrode being disposed on a first side of said first dielectric plate and said second opposite polarity electrode being disposed on said first side of said first dielectric plate;
wherein said second dielectric plate includes a first cutout region disposed at a first end of said second dielectric plate suitable for attachment of a first electrical busline and a second cutout region disposed at a second end of said second dielectric plate suitable for attachment of a second electrical busline; and
wherein said first and second dielectric plates are laminated together to provide said co-planar surface discharge element.

42. The method for treating a combustion exhaust stream of claim 34, wherein said surface discharge gaps formed between adjacent pairs of said reactor elements comprise an alternating series of positive and negative surface discharge gaps.

43. The method for treating a combustion exhaust stream of claim 34, wherein said surface discharge gaps formed between adjacent pairs of said reactor elements comprise all positive surface discharge gaps.

44. The method for treating a combustion exhaust stream of claim 34, wherein said surface discharge gaps formed between adjacent pairs of said reactor elements comprise all negative surface discharge gaps.
